(19) United States
(12) Patent Application Publication
(10) Pub. No.: US 2026/0064081 A1
(43) Pub. Date: Mar. 5, 2026

(54) ARM-WEARABLE DEVICE, TIMEPIECE, END PIECE, AND METHOD OF MAKING ARM-WEARABLE DEVICE

(71) Applicant: CASIO COMPUTER CO., LTD., Tokyo (JP)

(72) Inventor: Yoshihiro KOBAYASHI, Tokyo (JP)

(73) Assignee: CASIO COMPUTER CO., LTD., Tokyo (JP)

(21) Appl. No.: 19/305,564

(22) Filed: Aug. 20, 2025

(30) Foreign Application Priority Data
Sep. 4, 2024 (JP) 2024-151911

(51) Int. Cl. G04B 37/16

(52) U.S. Cl. CPC G04B 37/16

(57) ABSTRACT

An arm-wearable device includes: a cylindrical case body extending in a first direction; a frame member disposed at one side in the first direction of the case body; and an exterior member disposed at the one side of the frame member. The case body and the exterior member are fixed by a fixing member. At least part of the frame member is held between the case body and the exterior member, so that the frame member is fixed.

### CROSS-REFERENCE TO RELATED APPLICATIONS

This application claims priority and benefit of Japanese Patent Application No. 2024-151911, filed on Sep. 4, 2024, the entire contents of which are incorporated herein by reference.

### TECHNICAL FIELD

The present disclosure relates to an arm-wearable device, a timepiece, an end piece, and a method of making the arm-wearable device.

### DESCRIPTION OF RELATED ART

In a known arm-wearable device, such as a wristwatch, end pieces that support the band are fixed to the case with fixing members, such as screws or spring rods (see Japanese Unexamined Utility Model Application Publication No. H6-84387, for example).

According to the present disclosure, there is provided an arm-wearable device including: a cylindrical case body extending in a first direction; a frame member disposed at one side in the first direction of the case body; and an exterior member disposed at the one side of the frame member, wherein: the case body and the exterior member are fixed by a fixing member, and at least part of the frame member is held between the case body and the exterior member, so that the frame member is fixed.

### BRIEF DESCRIPTION OF DRAWINGS

FIG. 1 is a perspective view of the main part of a timepiece according to an embodiment.

FIG. 2 is an exploded perspective view of the main part of the timepiece according to the embodiment.

FIG. 3 is a cross-sectional view of part of the timepiece along the twelve o'clock-six o'clock direction according to the embodiment.

FIG. 4 is a perspective view of an end piece according to the embodiment.

FIG. 5 is a diagram for explaining a first step in assembling the timepiece according to the embodiment.

FIG. 6 is a diagram for explaining the first step in assembling the timepiece according to the embodiment.

FIG. 7 is a diagram for explaining the first step in assembling the timepiece according to the embodiment.

FIG. 8 is a diagram for explaining the first step in assembling the timepiece according to the embodiment.

FIG. 9 is a diagram for explaining a second step in assembling the timepiece according to the embodiment.

FIG. 10 is a diagram for explaining the second step in assembling the timepiece according to the embodiment.

FIG. 11 is a diagram for explaining a third step in assembling the timepiece according to the embodiment.

FIG. 12 is a diagram for explaining the third step in assembling the timepiece according to the embodiment.

FIG. 13 is a diagram for explaining a fourth step in assembling the timepiece according to the embodiment.

FIG. 14 is a perspective view of the main part of the timepiece according to the embodiment.

### DETAILED DESCRIPTION

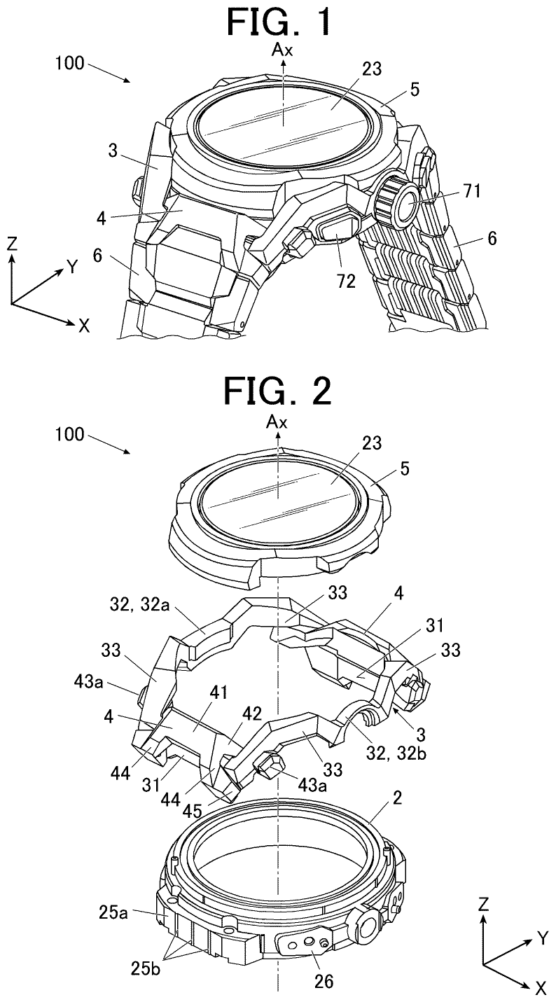

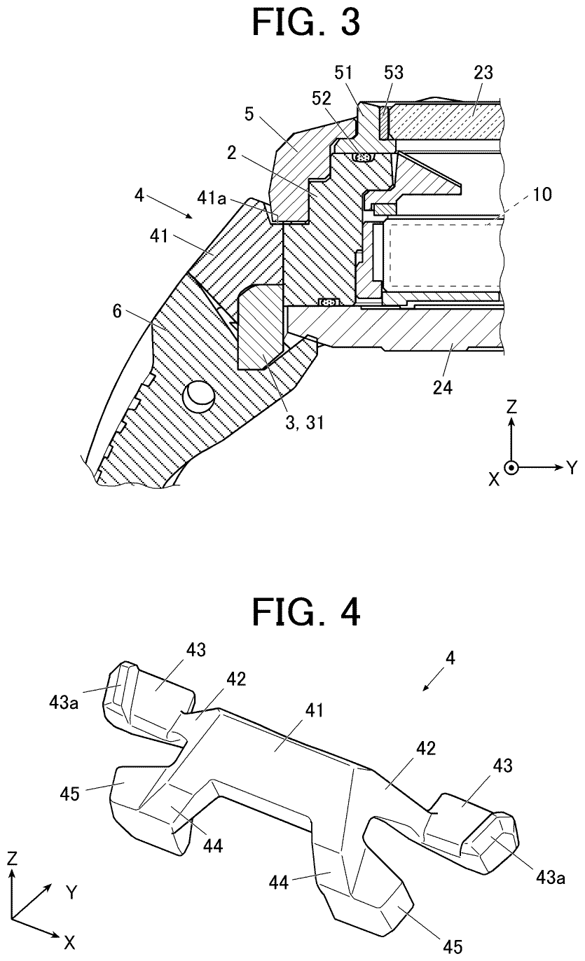

Hereinafter, an embodiment of the present disclosure will be described with reference to the figures. As illustrated in FIG. 1 to FIG. 3, the timepiece 100 in this embodiment is a wristwatch wearable on the wrist of a user. The timepiece 100 is an example of an arm-wearable device of the present disclosure. Specifically, the timepiece 100 includes a case body 2, a frame member 3, end pieces 4, and an exterior member 5. In the following description, X, Y, and Z directions of the timepiece 100 are directions illustrated in the figures. Specifically, the X direction is along the three o'clock-nine o'clock direction of an analog timepiece; the Y direction (second direction) is along the twelve o'clock-six o'clock direction; and the Z direction (first direction) is along the front face-back face direction of the timepiece 100 (case body 2). The front face side (visible side) in the Z direction is referred to as the upper side (upward), and the back face side is referred to as the lower side (downward). The direction perpendicular to the central axis Ax of the case body 2 that extends in the Z direction is referred to as the radial direction. The rotational direction on the central axis Ax is referred to as the circumferential direction. On a plane perpendicular to the central axis Ax, the side closer to the central axis Ax is referred to as the inside (inner diameter side), and the side farther from the central axis Ax is referred to as the outside (outer diameter side).

The case body 2 has a substantially cylindrical shape extending in the Z direction. The opening of the case body 2 at the back face side (lower side) is covered with a back cover 24. The case body 2 is made of metal, such as titanium or stainless steel, or hard resin, such as carbon or diamide, for example. The case body 2 houses a timepiece module 10. The timepiece module 10 includes a time display that displays time, a battery as a power source, and a circuit board on which a control circuit is mounted, for example. The top-view shape of the case body 2 is not limited to a circular shape but may be a polygonal shape, such as a square, for example.

On both side faces 25a in the Y direction of the case body 2, multiple protrusions (dowels) 25b are formed. In this embodiment, three protrusions 25b are formed. The side faces 25a are substantially flat and perpendicular to the Y direction. The protrusions 25b are formed substantially in the X direction on the side faces 25a. The protrusions 25b extend in the Y direction. The cross section of each protrusion 25b is triangular, for example. The protrusions 25b press the frame member 3 and the end pieces 4 and thereby fix them, as described later.

The frame member 3 supports the end pieces 4. In a top view, the frame member 3 has a ring shape corresponding to the shape of the case body 2. The frame member 3 is disposed on the upper side of the case body 2. The frame member 3 is made of hard resin, such as carbon or diamide. It is preferable that the frame member 3 be made of material softer than the end pieces 4.

At both ends in the Y direction of the frame member 3, support parts 31 are formed to support the end pieces 4. The support parts 31 are bar-shaped and extend substantially in the X direction. At both ends of the frame member 3 in the X direction and at the central part of the frame member 3 in the Y direction, lateral parts 32 are formed. The lateral parts 32 extend substantially in the Y direction in a top view. Among the lateral parts 32, the lateral part 32a at the nine-o'clock side has a bar shape extending substantially in the Y direction; and the lateral part 32b at the three-o'clock side has a curved bar shape protruding upwards to correspond to a crown 71. The frame member 3 has curved parts 33 that have a curved bar shape protruding upwards. The curved parts 33 each connect the support part 31 and the lateral part 32. The curved parts 33 protrude upward beyond the support parts 31 and the lateral parts 32, and the frame member 3 has a wavy shape that waves in the up-down direction as a whole. In a top view, the curved parts 33 extend diagonally toward the inside of the X direction as the curved parts 33 extend outside in the Y direction. The curved parts 33 are disposed at positions corresponding to a button attachment part(s) 26 of the case body 2 that supports an operation button 72. The curved parts 33 protrude to the outer circumferential side of the exterior member 5.

The end pieces 4 support a band 6 and are attached at both end sides in the Y direction of the frame member 3. The end pieces 4 are made of metal, such as titanium or stainless, for example. Specifically, the end pieces 4 each include a base 41, two first leg parts 42, two projections 43, two second leg parts 44, and two foot parts 45, as illustrated in FIG. 4.

The base 41 is formed to extend substantially in the X direction. The two first leg parts 42 extend diagonally from both X-direction ends of the base 41. At least part of each first leg part 42 slopes. Specifically, in a top view, the first leg parts 42 each extend gradually outward in the X direction as the first leg parts 42 extend inward in the Y direction. Further, when viewed in the X direction, the first leg parts 42 each extend gradually downward as the first leg parts 42 extend inward in the Y direction. The two projections 43 are formed at the respective ends of the two first leg parts 42. The projections 43 project outward in the X direction from the respective ends (lower ends) of the first leg parts 42. At the outside end in the X direction of each projection 43, a lock part 43a that projects upward is formed. The two leg parts 44 extend downward from both X-direction ends of the base 41. The leg parts 44 are at the outside of the first leg parts 42 in the Y direction. The two foot parts 45 are formed at the ends of the respective two second leg parts 44. On the inside surfaces in the X direction of the two foot parts 45, which face each other in the X direction, a not-illustrated spring bar is attached along the X direction. To the spring bar, the band 6 is fixed. The two foot parts 45 project outward in the X direction from the ends (lower ends) of the respective second leg parts 44 such that the foot parts 45 are substantially parallel to the X direction. The assembled state of the end piece 4 and the assembling process are described in detail later.

The exterior member 5 has a ring shape corresponding to the shape of the case body 2 in a top view, as illustrated in FIG. 1 to FIG. 3. The exterior member 5 is disposed on the upper side of the case body 2. The exterior member 5 is made of metal, such as titanium or stainless, or hard resin, such as carbon, for example. At the inner diameter side of the exterior member 5, a holding member 51 is disposed. In the holding member 51, a windshield member 23 is fitted with a cushioning member 53 (e.g., gasket) in-between. The holding member 51 is disposed on the upper side of the case body 2 in a state where a cushioning member 52 (e.g., O-ring) is held between the case body 2 and the cushioning member 51. The exterior member 5 and the case body 2 sandwich the holding member 51 in the up-down direction. Further, the exterior member 5 and the case body 2 sandwich the lateral parts 32, which are formed at the central part in the Y direction of the frame member 3, in the up-down direction. The exterior member 5 and the case body 2 sandwich (hold) at least part of the frame member 3. The exterior member 5 is disposed at the upper side of a stepped part 41a formed at the inner end of the base 41 of each end piece 4. Thus, the exterior member 5 restrains the end pieces 4 from moving upward (rotating). The top-view shape of the exterior member 5 corresponds to the case body 2.

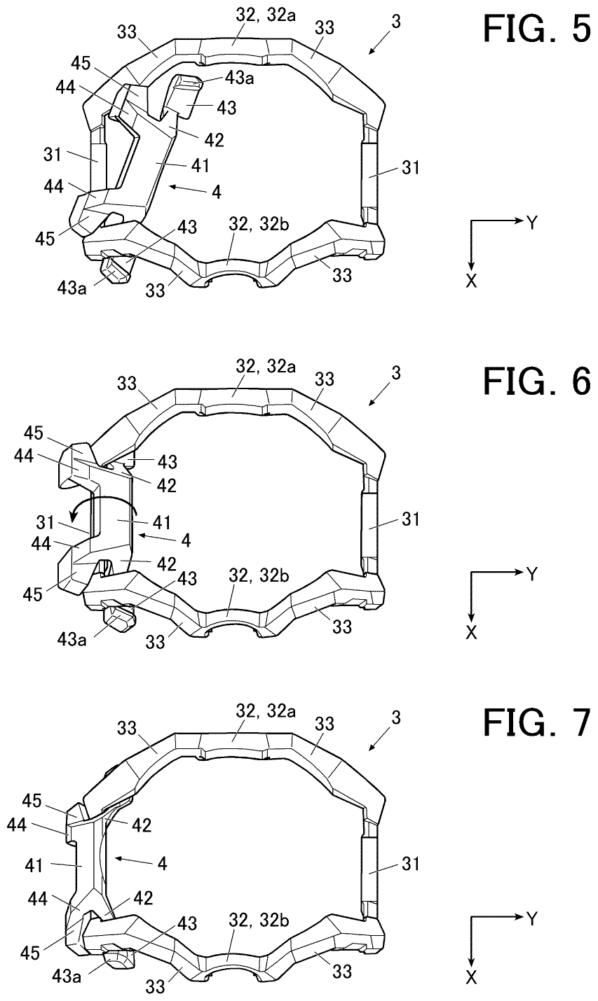

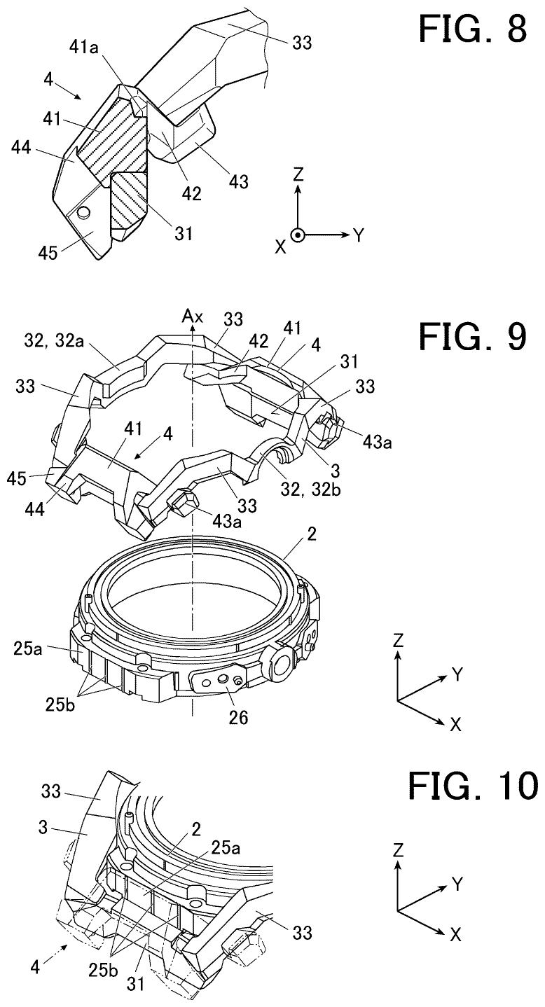

Next, the assembling process of the timepiece 100 is described. Description is omitted regarding the attachment of the timepiece module 10, the back cover 24, the crown 71, the operation button 72, and so forth. First, the end pieces 4 are attached to the respective support parts 31 of the frame member 3 (first step). As illustrated in FIG. 5, the two first leg parts 42 of each end piece 4 are passed below the two curved parts 33 of the frame member 3 such that the base 41 comes above the support part 31. Thus, the end piece 4 is caught on the support part 31 from the inside of the frame member 3. Next, as indicated by the arrow in FIG. 6, the end piece 4 is rotated on an X-direction axis such that the second leg parts 44 are moved downward. Accordingly, as illustrated in FIG. 7 and FIG. 8, the end piece 4 is attached to the frame member 3 in a state where (i) the top surfaces of the projections 43 are in contact with the bottom surfaces of the curved parts 33, or the inside surfaces of the foot parts 45 are in contact with the outside surface of the support part 31, and (ii) the bottom surface of the base 41 is in contact with the top surface of the support part 31. Herein, the lock parts 43a formed at the ends of the projections 43 are locked to the outside surfaces of the curved parts 33.

Next, as illustrated in FIG. 9, the frame member 3 to which the two end pieces 4 have been attached is attached to the case body 2 (second step). The frame member 3 is attached to the case body 2 from above (from the front face side) in a state where the two end pieces 4 are at both ends in the Y direction. Herein, as illustrated in FIG. 10, the protrusions 25b, which are formed at both of the side faces 25b of the case body 2, press the support parts 31 of the frame member 3 and the bases 41 of the end pieces 4 in the outward direction. Thus, the frame member 3, the end pieces 4, and the case body 2 are firmly (and temporarily) fixed in a state where the frame member 3 and the end pieces 4 are pressed in both end sides of the Y direction.

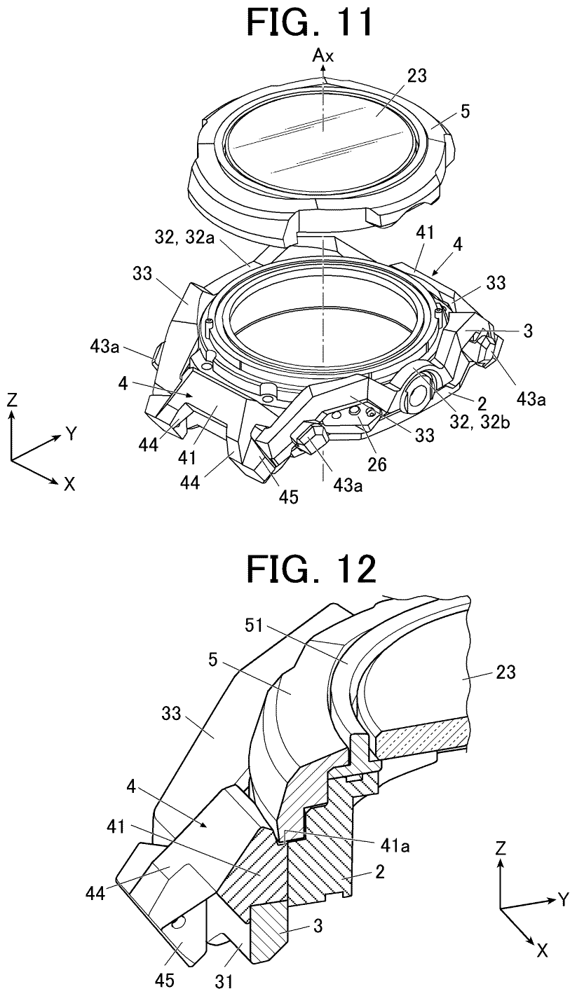

Next, as illustrated in FIG. 11, the exterior member 5 is attached to the case body 2 (third step). Herein, the holding member 51 in which the windshield member 23 is fitted is attached to the exterior member 5 beforehand. Then, in a state where the cushioning member 52 (omitted in FIG. 11) is disposed on the case body 2, the exterior member 5 is attached to the case body 2 and the frame member 3 from above (from the front face side). Accordingly, the lateral parts 32 at the central part in the Y direction of the frame member 3 are held between the exterior member 5 and the case body 2 in the up-down direction, and the frame member 3 is fixed. As illustrated in FIG. 12, the exterior member 5 is disposed at the upper side of the stepped parts 41a of the end pieces 4. Thus, the end pieces 4 are restrained from moving upward (rotating). Herein, the exterior member 5 may be temporarily fixed to the case body 2 using glue or the like, for example.

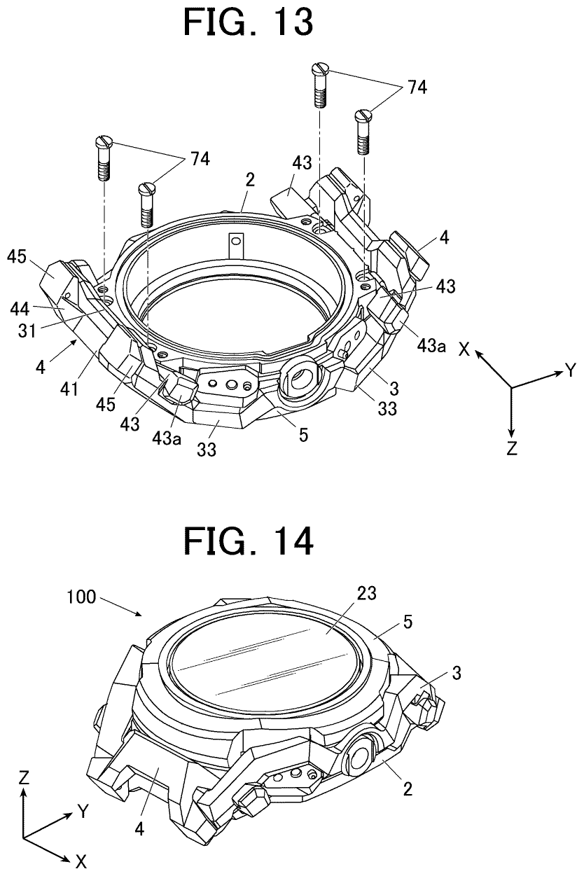

Next, as illustrated in FIG. 13, the case body 2 and the exterior member 5 are fixed from the back face side using fixing members 74 (fourth step). The fixing members 74 are screws, for example. Thus, the main part of the timepiece 100 is assembled as illustrated in FIG. 14. The band 6 is then attached to the two end pieces 4 via a not-illustrated spring bar. Thus, the main part of the timepiece 100 is assembled.

As described above, according to this embodiment, the case body 2 and the exterior member 5 are fixed by the fixing members 74; and at least part of the frame member 3 is held between the case body 2 and the exterior member 5, so that the frame member 3 is fixed. That is, when the case body 2 and the exterior member 5 are fixed by the fixing members 74, the frame member 3 is also fixed by being held between the case body 2 and the exterior member 5, and the end pieces 4 are fixed to the frame member 3. Such a structure does not require fixing members for fixing end pieces, unlike a structure in which end pieces and an exterior member are individually fixed to the case using fixing members. Therefore, the end pieces 4 and the exterior member 5 can be fixed to the case body 2 using less parts. Further, by eliminating the need of fixing members for fixing end pieces, an arm-wearable device can be designed more freely with a lower cost, and the end pieces 4 can be made compact.

In a known arm-wearable device, such as wristwatch, end pieces that support the band are fixed to the case by fixing members, such as screws or spring rods (see Japanese Unexamined Utility Model Application Publication No. H6-84387, for example). However, such a structure requires additional fixing members for fixing an exterior member (e.g., bezel) to the case. According to the present disclosure, the end pieces and the exterior member can be fixed to the case using less parts.

Further, according to this embodiment, the lateral parts 32 formed at the central part in the Y direction of the frame member 3 are held between the case body 2 and the exterior member 5. Such a structure can appropriately lessen an impact. For example, when the timepiece 100 receives an impact from the front face side by being dropped, both ends of the frame member 3 in the Y direction, where the end pieces 4 for supporting the band 6 are attached, receive a greater impact. Because the lateral parts 32 at the central part in the Y direction of the frame member 3 are supported, the frame member 3 deforms in the up-down direction as a whole on the lateral parts 32 as a fulcrum, so that the impact can be appropriately lessened.

Further, according to this embodiment, the frame member 3 has a wave shape that waves in the up-down direction. For example, when the timepiece 100 receives an impact from its front face side by being dropped, the frame member 3 having such a shape can appropriately deform in the up-down direction and lessen the impact.

Further, according to this embodiment, the end pieces 4 each include a part that comes inside the frame member 3 in a state where the end piece 4 is attached to the frame member 3. On the side faces 25a in the Y direction of the case body 2, the protrusions 25a that press the frame member 3 and the end pieces 4 outward in the Y direction are formed. According to such a structure, the frame member 3 and the end pieces 4 are pressed such that the frame member 3 is pulled outward in the Y direction while the end pieces 4 are pressed against the frame member 3. Thus, the frame member 3 and the end pieces 4 can be appropriately fixed.

Further, according to this embodiment, the frame member 3 is made of material softer than the end pieces 4. Thus, the end pieces 4 can be supported appropriately and attached to the frame member 3 more certainly, as compared with a case where the frame member 3 and the end pieces 4 are both made of metal, for example. Further, because the end pieces 4 are made of metal in this embodiment, the end pieces 4 can firmly support the band 6.

Further, according to this embodiment, the end piece 4 includes: the base 41; the first leg parts 42 that extend from both ends in the longitudinal direction of the base 41 such that at least part of each of the first leg parts 42 slopes; the projections 43 formed at ends of the respective first leg parts 42; the second leg parts 44 that extend from both ends in the longitudinal direction of the base 41 such that the second leg parts 44 extend in one side of a direction crossing the longitudinal direction; and the foot parts 45 that are formed at ends of the respective second leg parts 44 and that protrude to be parallel to the longitudinal direction of the base 41. According to such a configuration, each of the end pieces 4 can be appropriately attached to the frame member 3 by: arranging the base 41 along the frame member 3; causing the first leg parts 42 and the second leg parts 44 to cross with the frame member 3; and causing the projections 43 and the foot parts 45 to be in contact with or caught on the frame member 3, for example. Although the frame member 3 cannot directly support the band 6 alone due to its rigidity, the end pieces 4 appropriately attached to the frame member 3 can support the band 6.

Further, according to this embodiment, in a state where the end piece 4 is attached to the frame member 3, the base 41 is at the front face side of the frame member 3, and the projections 43 are at the back face side of the frame member 3. According to such a structure, the end piece 4 can be appropriately attached to the frame member 3 such that the base 41 and the projections 43 of the end piece 4 catch the frame member 3 from above and below.

Embodiments to which the present disclosure is applicable are not limited to the above-described embodiment and can be variously modified without departing from the present disclosure. For example, in the above embodiment, a wristwatch is explained as an example of the arm-wearable device according to the present disclosure. However, the present disclosure is widely applicable not only to a wristwatch but also to various arm-wearable devices, such as various smartwatches, electronic devices (e.g., sports watches), and wearable devices that obtain biometric information (e.g., heartbeat and blood flow) as well as time, for example.

1. An arm-wearable device comprising:
a cylindrical case body extending in a first direction;
a frame member disposed at one side in the first direction of the case body; and
an exterior member disposed at the one side of the frame member, wherein:
the case body and the exterior member are fixed by a fixing member, and
at least part of the frame member is held between the case body and the exterior member, so that the frame member is fixed.

2. The arm-wearable device according to claim 1, wherein:
a second direction is perpendicular to the first direction, and
a central part in the second direction of the frame member is held between the case body and the exterior member.

3. The arm-wearable device according to claim 1, wherein the frame member has a wavy shape that waves in the first direction.

4. The arm-wearable device according to claim 1, wherein:
a second direction is perpendicular to the first direction, and
protrusions are formed on side faces in the second direction of the case body, the protrusions pressing the frame member outward of the frame member in the second direction in a state where the frame member is attached to the case body.

5. The arm-wearable device according to claim 1, further comprising end pieces attached to both ends in a second direction of the frame member, the second direction being perpendicular to the first direction, wherein:
the end pieces each include a part that is disposed inside the frame member in a state where the end pieces are attached to the frame member, and
protrusions are formed on side faces in the second direction of the case body, the protrusions pressing the end pieces and the frame member outward of the frame member in the second direction in a state where the end pieces and the frame member are attached to the case body.

6. The arm-wearable device according to claim 5, wherein the frame member is made of material softer than the end pieces.

7. The arm-wearable device according to claim 5, wherein the end pieces are made of metal.

8. A timepiece comprising the arm-wearable device according to claim 1, wherein:
the case body houses a timepiece module, and
the frame member and the exterior member are disposed at a front face side of the case body.

9. An end piece of an arm-wearable device, the end piece being attached to a frame member and supporting a band, the end piece comprising:
a base;
first leg parts that extend from both of longitudinal-direction ends of the base such that at least part of each of the first leg parts slopes;
projections formed at ends of the respective first leg parts,
second leg parts that extend from both of the longitudinal-direction ends of the base such that the second leg parts extend in one side of a direction different from a direction in which the first leg parts extend; and
foot parts that are formed at ends of the respective second leg parts and that protrude to be substantially parallel to the longitudinal direction of the base.

10. The end piece according to claim 9, wherein, in a state where the end piece is attached to the frame member, the frame member is disposed between the first leg parts and the second leg parts, and at least part of the projections and at least part of the foot parts are in contact with the frame member.

11. The end piece according to claim 9, wherein, in a state where the end piece is attached to the frame member, the base is disposed at a front face side of the frame member, and the projections are disposed at a back face side of the frame member.

12. A method of making an arm-wearable device that includes a cylindrical case body extending in a first direction, the method comprising:
attaching end pieces to both ends in a second direction of a frame member, the second direction being perpendicular to the first direction;
attaching the frame member, to which the end pieces have been attached, to one end in the first direction of the case body;
disposing an exterior member at the one end of the frame member and the case body and holding at least part of the frame member between the case body and the exterior member; and
fixing the case body and the exterior member by a fixing member.

13. The method according to claim 12, wherein the end pieces each include:
a base;
first leg parts that extend from both of longitudinal-direction ends of the base such that at least part of each of the first leg parts slopes;
projections formed at ends of the respective first leg parts,
second leg parts that extend from both of the longitudinal-direction ends of the base such that the second leg parts extend in one side of a direction different from a direction in which the first leg parts extend; and
foot parts that are formed at ends of the respective second leg parts and that protrude to be substantially parallel to the longitudinal direction of the base,
wherein each of the end pieces is attached to the frame member by disposing the frame member between the first leg parts and the second leg parts and causing at least part of the projections and at least part of the foot parts to be in contact with the frame member.

14. The method according to claim 12, wherein:
the end pieces each include a part that is disposed inside the frame member in a state where the end pieces are attached to the frame member, and
in a state where the end pieces and the frame member are attached to the case body, protrusions formed on side faces in the second direction of the case body press the end pieces and the frame member outward of the frame member in the second direction.

15. The method according to claim 12, wherein a central part in the second direction of the frame member is held between the case body and the exterior member.
